(19) United States
(12) Patent Application Publication
(10) Pub. No.: US 2025/0340124 A1
(43) Pub. Date: Nov. 6, 2025

(54) SYSTEM FOR INDUCTIVELY TRANSFERRING POWER AND DATA

(71) Applicant: Telemattica Corporation Pty Ltd, Eveleigh (AU)

(72) Inventors: Thomas George, Sydney (AU); Timothy Vale, Sydney (AU)

(21) Appl. No.: 19/196,373

(22) Filed: May 1, 2025

Related U.S. Application Data
(60) Provisional application No. 63/641,813, filed on May 2, 2024.

(51) Int. Cl. B60L 5/20; H02J 50/10

(52) U.S. Cl. CPC B60L 5/20; H02J 50/10

(57) ABSTRACT

A system includes an isolator module including: core rod; a transmitter inductor; a receiver inductor; and sheds. The core rod includes: an input blind bore; an output blind bore; and an insulation barrier interposed between the input blind bore and the output blind bore. The transmitter inductor: is configured to receive a first power signal from an input power supply; and arranged on a first base of the input blind bore across the insulation barrier. The receiver inductor: is arranged on a second base, offset first base, of the output blind bore across the insulation barrier; configured to inductively couple to the transmitter inductor; and configured to output a second power signal approximating the first power signal, to a sensor module. The set of sheds: are arranged about the core rod; and cooperating with the insulation barrier to electrically isolate the input power supply from the sensor module floating.

### CROSS-REFERENCE TO RELATED APPLICATIONS

This Application claims the benefit of U.S. Provisional Application No. 63/641,813, filed on 2 May 2024, which is hereby incorporated in its entirety by this reference.

### TECHNICAL FIELD

This invention relates generally to the field of railway electrification and, more specifically, to a new and useful system for inductively transferring power and data in the field of railway electrification.

### BRIEF DESCRIPTION OF THE FIGURES

FIG. 1 is a schematic representation of a system;

FIGS. 2A and 2B are schematic representations of the system;

FIG. 3 is a schematic representation of the system;

FIG. 4 is a schematic representation of the system;

FIGS. 5A and 5B are schematic representations of the system;

FIG. 6 is a schematic representation of the system; and

FIGS. 7A and 7B are schematic representations of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

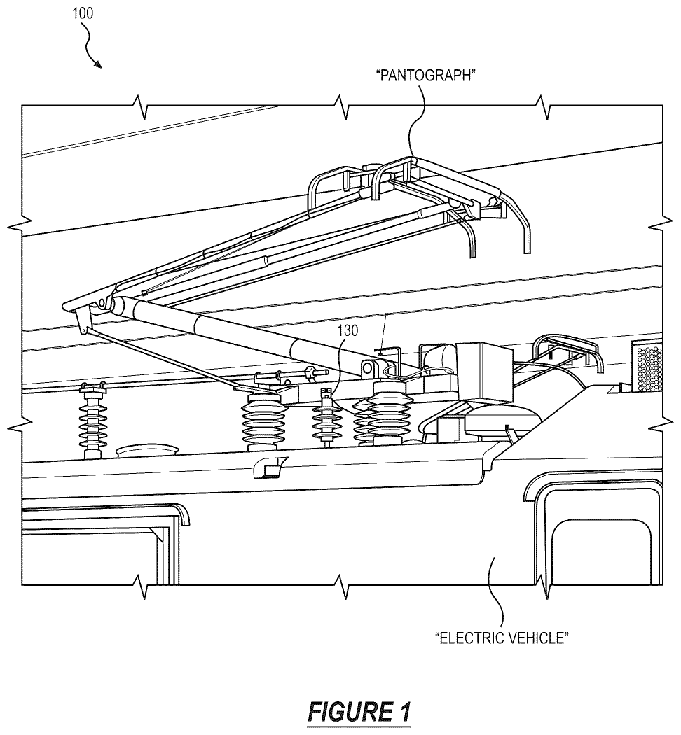

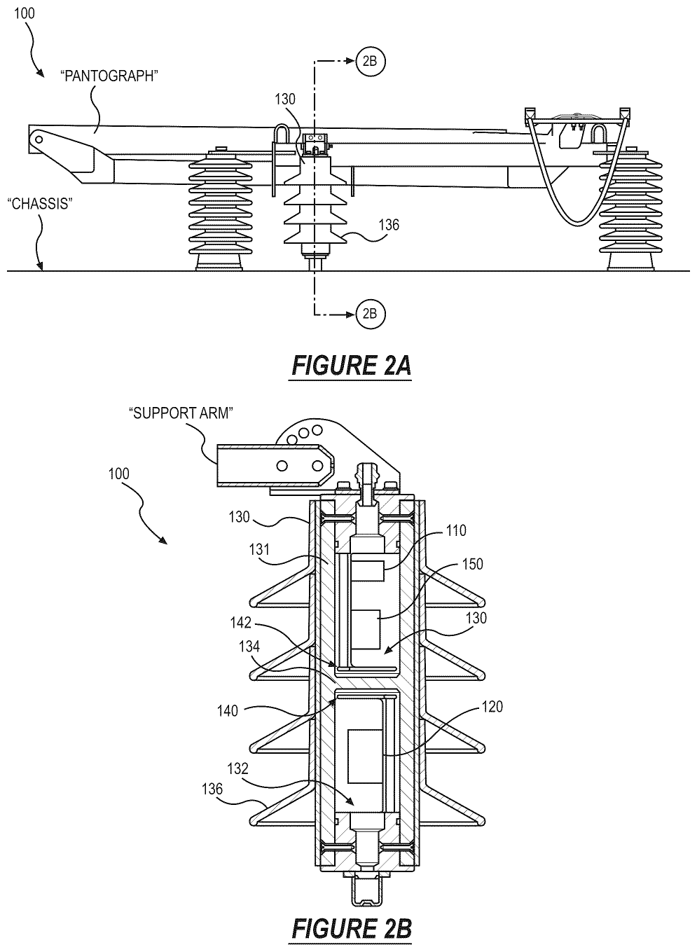

As shown in FIGS. 1, 2A and 2B, a system 100 includes: a primary isolator module 130; a sensor module 110 (or “electronics module”) connected to an output-side of the primary isolator module 130 floating at a target potential of equipment within a high-voltage arena; an input power supply 120 circuit connected to an input-side of the primary isolator module 130; and an output power supply 150 circuit connected to an output-side of the primary isolator module 130.

The primary isolator module 130 includes: a primary core rod 131; and a primary set of sheds 136 arranged about (e.g., encircling) the primary core rod 131. The primary core rod 131 defines: a primary input-side blind bore 132; and a primary output-side blind bore 133 concentric with the primary input-side blind bore 132. The primary core rod 131 further includes a primary insulation barrier 134: interposed between the primary input-side blind bore 132 and the primary output-side blind bore 133; and that offsets a primary base of the primary input-side blind bore 132 from a secondary base of the primary output-side blind bore 133. The primary set of sheds 136: define a total creepage distance (e.g., creepage length, leakage distance) along a longitudinal axis of the primary core rod 131; and are configured to yield electrical creepage between the input-side potential and the output-side potential.

The sensor module 110 includes: an inertial sensor; a controller 190; a wireless communication module configured to wirelessly transmit data interpreted from these signals; and/or a battery configured to power the inertial sensor, the controller 190, and the wireless communication module. The sensor module 110 is further configured to locate within the primary output-side blind bore 133 within the primary core rod 131 of the primary isolator module 130.

The input power supply 120 circuit includes: an input supply stage that accepts power from an auxiliary power supply (e.g. a low-voltage AC or DC circuit); a power transmission stage, including a primary transmitter inductor 140 and driver circuitry arranged on the primary base of the primary input-side blind bore 132 across the primary insulation barrier 134 of the primary isolator module 130; and/or a primary data transceiver 122 configured to convert a data signal from an input connector into a composite data signal and to pass the composite data signal to the primary transmitter inductor 140.

The output power supply 150 circuit includes a primary receiver inductor 142: arranged on the secondary base of the primary output-side blind bore 133, across the primary insulation barrier 134, and opposite and coaxial with the primary transmitter inductor 140; configured to inductively couple to the primary transmitter inductor 140; and configured to output a secondary alternating current power signal that follows the primary alternating current power signal. The output power supply 150 circuit also includes: an AC-to-DC converter configured to convert the secondary alternating current power signal, output by the secondary inductor at the power transmit frequency, into a third direct current power signal; (a DC-to-DC converter configured to convert the third direct current power signal into a fourth direct current power signal approximating the primary direct current power signal;) and an output voltage supply line configured to supply the fourth direct current power signal to the output connector; and/or a secondary data transceiver configured to convert a composite data signal output by the primary receiver inductor 142 into an output data signal.

### 1.1 Variation: Auxiliary Power Supply+Sensor Module Isolation

In one variation, as shown in FIGS. 1, 2A and 2B, the system 100 includes: a sensor module 110 (or “electronics module”); an input power supply 120; a primary isolator module 130; and an output power supply 150.

The sensor module 110 is floating at a voltage potential of a pantograph arranged on an electric vehicle.

The input power supply 120 is configured to: receive a direct-current input voltage from an auxiliary power supply electrically referenced to a ground potential of a chassis of the electric vehicle; and convert the direct-current input voltage into an alternating power signal.

The primary isolator module 130 is interposed between the pantograph and the chassis of the electric vehicle and includes: a primary core rod 131; a primary transmitter inductor 140; a primary receiver inductor 142; and a primary set of sheds 136.

The primary core rod 131 includes: a primary input-side blind bore 132; a primary output-side blind bore 133 concentric with the primary input-side blind bore 132; and a primary insulation barrier 134 interposed between the primary input-side blind bore 132 and the primary output-side blind bore 133.

The primary transmitter inductor 140: is configured to receive the alternating power signal from the input power supply 120; is configured to output an intermediate alternating power signal based on the alternating power signal; and is arranged on a first base of the primary input-side blind bore 132 across the primary insulation barrier 134.

The primary receiver inductor 142: is arranged on a second base of the primary output-side blind bore 133, offset from the first base of the primary input-side blind bore 132, across the primary insulation barrier 134; is coaxial with the primary transmitter inductor 140; is configured to receive the intermediate alternating power signal by inductively coupling to the primary transmitter inductor 140 across the primary insulation barrier 134; and is configured to output a second alternating power signal, following the alternating power signal, based on the intermediate alternating power signal.

The primary set of sheds 136: are arranged about the primary core rod 131; and cooperate with the primary insulation barrier 134 to electrically isolate the auxiliary power supply, electrically referenced to the ground potential of the chassis, from the sensor module 110 floating at the voltage potential of the pantograph.

The output power supply 150 is configured to: receive the second alternating power signal from the primary receiver inductor 142; convert the second alternating power signal into a direct-current output voltage relative to the voltage potential at the pantograph; and supply the direct-current output voltage to the sensor module 110.

### 1.2 Variation: Input Power Supply+Sensor Module Isolation

In one variation, as shown in FIGS. 1, 2A and 2B, the system 100 includes: a sensor module 110 (or “electronics module”); an input power supply 120; a primary isolator module 130; and an output power supply 150.

The sensor module 110 is floating at a voltage potential of a pantograph arranged on an electric vehicle.

The input power supply 120: is electrically referenced to a ground potential at a chassis of the electric vehicle; and configured to output an alternating power signal.

The primary isolator module 130 is interposed between the pantograph and the chassis of the electric vehicle and includes: a primary core rod 131; a primary transmitter inductor 140; a primary receiver inductor 142; and a primary set of sheds 136.

The primary core rod 131 includes: a primary input-side blind bore 132; a primary output-side blind bore 133 concentric with the primary input-side blind bore 132; and a primary insulation barrier 134 interposed between the primary input-side blind bore 132 and the primary output-side blind bore 133.

The primary transmitter inductor 140: is configured to receive the alternating power signal; and is arranged on a first base of the primary input-side blind bore 132 across the primary insulation barrier 134.

The primary receiver inductor 142: is arranged on a second base of the primary output-side blind bore 133, offset from the first base of the primary input-side blind bore 132, across the primary insulation barrier 134; is coaxial with the primary transmitter inductor 140; and is configured to receive the alternating power signal by inductively coupling to the primary transmitter inductor 140 across the primary insulation barrier 134.

The primary set of sheds 136: are arranged about the primary core rod 131; and cooperate with the primary insulation barrier 134 to electrically isolate the input power supply 120, electrically referenced to the ground potential of the chassis, from the sensor module 110 floating at the voltage potential of the pantograph.

The output power supply 150 is configured to: receive the alternating power signal from the primary receiver inductor 142; convert the alternating power signal into a direct-current output voltage relative to the voltage potential at the pantograph; and output the direct-current output voltage to the sensor module 110.

### 1.3 Variation: Isolator Module

In one variation, as shown in FIGS. 1, 2A and 2B, a primary isolator module 130 includes: a primary core rod 131; a primary transmitter inductor 140; a primary receiver inductor 142; and a primary set of sheds 136.

The primary core rod 131 includes: a primary input-side blind bore 132; a primary output-side blind bore 133 concentric with the input-side blind bore 132; and a primary insulation barrier 134 interposed between the primary input-side blind bore 132 and the primary output-side blind bore 133.

The primary transmitter inductor 140: is arranged on a first base of the primary input-side blind bore 132 across the primary insulation barrier 134; and is configured to receive a first power signal from a power supply electrically referenced to a first potential.

The primary receiver inductor 142: is arranged on a second base of the primary output-side blind bore 133, offset from the first base of the primary input-side blind bore 132, across the primary insulation barrier 134; is coaxial with the primary transmitter inductor 140; is configured to inductively couple to the primary transmitter inductor 140; and is configured to output a second power signal, following the first power signal, to a sensor module 110 floating at a second potential greater than the first potential.

The primary set of sheds 136: are arranged about the primary core rod 131; and cooperate with the primary insulation barrier 134 to electrically isolate the power supply, electrically referenced to the first potential, from the sensor module 110 floating at the second potential.

### 2. Applications

Generally, the system 100 functions as an isolated power supply bridge from a low-voltage arena (i.e., an input-side potential) to a high-voltage arena (i.e., an output-side potential) such as: from a low-voltage auxiliary supply of an electric locomotive; to a pantograph and affiliated structure in contact with overhead cables supplying high-voltage. In particular, the system 100 includes: an insulator housing with a row of sheds configured to prevent current conduction between the input-side and output-side potentials; a primary transmitter inductor 140 arranged within the insulator housing on the input side of the insulator housing; a primary receiver inductor 142 similarly located within the insulator housing on the output side of the insulator housing and facing, coaxial with, and offset from the primary transmitter inductor 140; and power and signal conditioning electronics.

More specifically, the input-side electronics: are coupled to an auxiliary power supply, such as a 24 VDC regulated power supply on a low-voltage power bus of an electric train, electric tram, or electric bus; convert a low-voltage direct current power signal into an alternating current power signal at a power transmit frequency (e.g., 200 kHz); and pass this alternating current power signal to the primary transmitter inductor 140. The primary receiver inductor 142 is inductively coupled to the primary transmitter inductor 140 and thus outputs a secondary alternating current power signal that follows the primary alternating current power signal at the power transmit frequency. The output-side electronics: convert this secondary alternating current power signal to a low-voltage direct current power signal (e.g., approximating the low-voltage direct current power signal); and supply this low-voltage direct current power signal to a direct current load arranged in the high-voltage arena, such as a set of sensors, an electric battery, a controller 190, and/or a wireless communication module arranged within the insulator housing or arranged in a separate housing electrically coupled to the output of the output-side electronics.

Therefore, the system 100 implements inductive charging techniques to supply electrical power from a low-voltage arena to a high-voltage arena—through a high-voltage insulator housing—via a pair of galvanically- and physically-isolated inductors that inductively couple through a primary insulation barrier 134 within the insulator housing. The system 100 can thus, supply electrical power from a low-voltage potential to a high-voltage potential with low-power electronics and an insulator housing formed in common insulator materials via common insulator fabrication methods while maintaining high resistance to puncture, breakdown and flashover arcs.

### 2.1 Data Communications

Furthermore, the input power supply 120 circuit includes: an input power line communications (or “PLC”) transceiver (e.g., an input driver and an input receiver); a primary transmitter inductor 140 configured to inductively couple to the primary receiver inductor 142 in the output power supply 150 circuit; an input high-pass filter 126 interposed between the primary transmitter inductor 140 and the input PLC transceiver 122; and an input isolation data-tap transformer 124 interposed between the input high-pass filter 126 and the primary transmitter inductor 140. The output power supply 150 circuit includes: the primary receiver inductor 142; a rectifier electrically coupled to the primary receiver inductor 142; an output PLC transceiver 152 (e.g., an output driver and an output receiver); an output high-pass filter 156 interposed between the primary receiver inductor 142 and the output PLC transceiver 152; and an output isolation data-tap transformer 154 interposed between the output high-pass filter 156 and the primary receiver inductor 142.

In a bi-directional configuration, the input and output drivers are configured to output an outbound data signal to the input and output isolation data-tap transformers 154. The input and output isolation data-tap transformers 154 are configured to superimpose the outbound data signal—at a data frequency (e.g., 10×, 100× greater than the power transmit frequency)—onto the alternating current power signal via capacitive coupling to generate a modulated data signal. The primary transmitter inductor 140 inductively couples to the primary receiver inductor 142 to pass the modulated data signal across the primary insulation barrier 134. The input and output high-pass filters 156 are coupled to the low-power side of the input and output isolation data-tap transformers 154 and configured to pass higher-frequency components of the composite signal, representing inbound and/or outbound data-over-power alternating current signals, at the data frequency to the input and output PLC transceiver and reject lower-frequency components of the composite signal approximating the power transmit frequency. Accordingly, the input and output PLC transceiver separate the inbound and/or outbound data signals from this higher-frequency component of the composite signal and outputs the inbound data signal or transmits the outbound data signal.

The system 100 is described herein: to inductively supply electrical power from an auxiliary power supply arranged on an electric locomotive to a battery and/or a sensor module 110 arranged within a high-voltage arena on the electric locomotive, such as a pantograph and supporting structure in contact with overhead high-voltage power lines; to inductively transfer downlink data signals between the sensor module 110 in the high-voltage arena to a connected device or controller 190 in a low-voltage arena; and to inductively transfer data uplink signals from the controller 190 in the low-voltage arena to the sensor module 110 in the high-voltage arena. However, the system 100 can: inductively transfer power and/or data signals between low- and high-voltage arenas on a light rail, high-speed, main-line, or underground train, a tram, a subway, a trolley bus, and/or a substation.

### 2.2 Example: Pantograph Abnormal Contact Detection

In one example, the system 100: inductively transfers power signals from an auxiliary power supply arranged on an electric train, across a set of inductors (e.g., windings) within a primary isolator module 130, and to a sensor module 110. The system 100 can also inductively transfer data signals—representing georeferenced vibration and roughness conditions of overhead power lines, which may be correlated with maintenance needs at particular locations along the overhead power lines—of a pantograph coupled to the electric train captured by the sensor module 110, across the set of inductors within the primary isolator module 130, and to a connected device (e.g., a computing device, a remote computer system 100) or user portal interface.

More specifically, the system 100 includes: a primary isolator module 130; an output power supply 150 circuit connected to the primary isolator module 130; and an input power supply 120 circuit connected to the primary isolator module 130. The primary isolator module 130 includes: a primary core rod 131 and a primary set of sheds 136 arranged about (e.g., encircling) the primary core rod 131. The primary core rod 131 defines: a primary input-side blind bore 132; and a primary output-side blind bore 133 concentric with the primary input-side blind bore 132. The primary core rod 131 further includes a primary insulation barrier 134: interposed between the primary input-side blind bore 132 and the primary output-side blind bore 133; and defines an offset distance between a primary base of the primary input-side blind bore 132 and a secondary base of the primary output-side blind bore 133. The primary set of sheds 136: define a total creepage distance (e.g., creepage length, leakage distance) along a longitudinal axis of the primary core rod 131; and are configured to maintain electrical creepage between the input-side potential and the output-side potential under expected external environmental conditions (e.g., heat, rainfall, ice, lightning, snow, salt, dust, or industrial pollution).

In this example, the system 100 further includes a sensor module 110, which includes an accelerometer 112, a compass, a wireless communication module, a controller 190, and/or a battery. The controller 190 can: access accelerometer data and location data of the pantograph while the electric train traverses a railway below the set of overhead transportation power lines; and serve these data, via the wireless communication module, to an operator of the electric train.

The controller 190 can also: access a signal—representing vibrations of the pantograph, in contact with the set of overhead transportation power lines—output by the accelerometer 112 as the electric train traverses a railway; store these timeseries vibration data in local memory; access geolocation data from a geospatial position module 114 arranged in or connected to the sensor module 110; tag or label these timeseries vibration data with geolocation data output by the geospatial position module 114; and offload these georeferenced timeseries vibration data to a remote computer system 100 via the wireless communication module or to another controller 190 on the electric train via a data downlink connection through the primary and secondary inductors.

For example, the remote computer system 100 can process these georeferenced timeseries vibrations to identify geolocations in which the pantograph exhibits abnormal oscillations, which may indicate excessive wear on the overhead transportation power line, or cable breaks in the overhead transportation power line, or erroneous loss of contact between the pantograph and the overhead transportation power lines. The remote computer system 100 can then: generate recommendations for maintenance or repair of the overhead transportation power line at these geolocations; and serve these recommendations to transportation maintenance personnel. Alternatively, the controller 190—located in the sensor module 110—can locally detect these wear locations, generate maintenance recommendations accordingly, and offload these maintenance recommendations via the wireless communication module or to another controller 190 on the electric train via a data downlink connection through the primary and secondary inductors.

Thus, the remote computer system 100 and/or the controller 190 can: access georeferenced accelerometer data representing oscillations of the pantograph in contact with overhead transportation power lines as the electric train traverses a railway; and generate and serve alerts, notifications, and/or recommendations, via the wireless communications module, to transportation maintenance personnel, thereby enabling transportation maintenance personnel to address immediate and/or preventative maintenance on the overhead transportation power lines and/or the pantograph.

### 3. Terms and Definitions

Generally, an “alternating power signal” as referred to herein encompasses any time-varying electromagnetic phenomenon associated with the transfer of electrical power through the system 100. For example, “alternating power signal” encompasses: alternating current or voltage waveforms generated and/or received by a power supply, such as the input power supply 120 or the output power supply 150; magnetic fields generated by these waveforms in an inductor, such as in the transmitter inductor 140 and/or the receiver inductor 142; magnetic coupling between inductors, such as between the transmitter inductor 140 and the receiver inductor 142 across the insulation barrier 134; and the resulting induced currents and voltages at the transmitter inductor 140 and/or the receiver inductor 142. Accordingly, the term “alternating power signal” covers energy propagation and transformation—electrical and magnetic—that occur as power is transferred from input-side of the system 100 to the output-side of the system 100 via inductive coupling.

### 4. Isolator Module

Generally, the system 100 can include a primary isolator module 130, which includes a primary core rod 131 and a primary set of sheds 136 arranged about (e.g., encircling) the primary core rod 131. The primary isolator module 130 is further connected to an output power supply 150 circuit; and an input power supply 120 circuit.

In one implementation, the system 100 includes a chassis mounted to a base frame of a pantograph and configured to support the primary isolator module 130 between the pantograph and a top surface of an electric locomotive, such as a light-rail, high-speed, or main-line train, tram, and/or subway. The chassis can include a bracket pivotably coupled to the base frame of the pantograph and configured to locate the primary isolator module 130 over a range of positions relative to the pantograph. In this implementation, the system 100 includes the chassis configured to couple the primary isolator module 130 to a base frame of a pantograph such that the system 100 can pass a primary direct current (e.g., a low-voltage direct current) power signal, from an external auxiliary power system 100 arranged on an electric locomotive, through the primary isolator module 130 via inductive coupling between a set of inductors, and toward a sensor module 110 proximal the pantograph via a wired connection, as further described below.

### 4.1 Core Rod: Blind Bores+Insulation Barrier

The primary core rod 131 defines: a primary input-side blind bore 132; and a primary output-side blind bore 133 concentric with the primary input-side blind bore 132. The primary core rod 131 further includes a primary insulation barrier 134: interposed between the primary input-side blind bore 132 and the primary output-side blind bore 133; and offsetting a primary base of the primary input-side blind bore 132 from a secondary base of the primary output-side blind bore 133 by a thickness (e.g., 30 millimeters).

In one implementation, the secondary base of the primary output-side blind bore 133 and the primary base of the primary input-side blind bore 132 are configured to house an inductor (e.g., a winding). Further, the primary base of the primary input-side blind bore 132 is characterized by a primary diameter: greater than a primary inductor diameter; and less than a secondary core rod 161 diameter. Similarly, the secondary base of the primary output-side blind bore 133: is concentric with the primary base of the primary input-side blind bore 132; and is characterized by a third diameter greater than a secondary inductor diameter and less than the secondary core rod 161 diameter.

Furthermore, the primary insulation barrier 134: is interposed between the secondary base of the primary output-side blind bore 133 and the primary base of the primary input-side blind bore 132; and defines a primary thickness approximating a target offset distance (e.g., a gap) between a primary inductor (e.g., a primary transmitter inductor 140), arranged on the primary base of the primary input-side blind bore 132, and a secondary inductor (e.g., a primary receiver inductor 142) arranged on the secondary base of the primary output-side blind bore 133. The primary inductor and the secondary inductor are further characterized by a coupling coefficient, such as a value between 0 and 1, partially based on: a primary size of the primary inductor; a secondary size of the secondary inductor; and the thickness of the primary insulation barrier 134. Alternatively, the coupling coefficient between the primary inductor and the secondary inductor is based on: a self-inductance of the primary inductor; a self-inductance of the secondary inductor; and a mutual inductance between the primary inductor and the secondary inductor.

For example, the primary inductor includes a transmitter multi-coil winding and is arranged on the primary base of the primary input-side blind bore 132. The secondary inductor includes a receiver multi-coil winding and is arranged on the secondary base of the primary output-side blind bore 133. The primary base of the primary input-side blind bore 132 is characterized by a primary diameter: greater than a diameter of the primary multi-coil inductor, such as 30 millimeters; and less than a diameter of the primary core rod 131, such as 70 millimeters. The secondary base of the primary output-side blind bore 133 is concentric with the base of the primary input-side blind bore 132 and is characterized by a secondary diameter: greater than a diameter of the secondary multi-coil inductor, such as 30 millimeters; and less than the diameter of the primary core rod 131, such as 70 millimeters. The transmitter multi-coil winding and the receiver multi-coil winding are further characterized by a coupling coefficient, such as 0.7, based on the diameter of the transmitter multi-coil winding (e.g., 30 millimeters), the diameter of the receiver multi-coil winding (e.g., 30 millimeters), and the thickness of the primary insulation barrier 134 (e.g., 30 millimeters). Thus, in this example, the thickness of the primary insulation barrier 134 is proportional to the coupling coefficient and enables the system 100 to inductively transfer a power signal between the transmitter multi-coil winding and the receiver multi-coil winding via magnetic flux.

### 4.2 Sheds

The primary set of sheds 136: are arranged about (e.g., encircling) the primary core rod 131; define a total creepage distance (e.g., creepage length, leakage distance) along a longitudinal axis of the primary core rod 131; and are configured to shield the primary core rod 131 from external environmental conditions (e.g., heat, rainfall, ice, lightning, snow, salt, dust, or industrial pollution). Further, each shed in the primary set of sheds 136: defines a minimum offset distance from each other shed; is characterized by a concentric disc shape; and is manufactured from an insulating material associated with a target dielectric strength (e.g., a polymeric material, a composite material, a glass material, a ceramic material).

In one variation, the primary set of sheds 136 are characterized by a target creepage distance along a lateral axis of the primary core rod 131, such as a sum of the diameter of each shed relative to an outer diameter of the primary core rod 131. The target creepage distance is a function of the maximum voltage capacity of a connected voltage supply, flashover voltage, puncture voltage, and/or the external environmental conditions proximal the primary isolator module 130. In one example, the target creepage distance is a function of the maximum voltage capacity and can include: increasing the target creepage distance for a high-voltage power supply, such as 12 kilovolts; or decreasing the target creepage distance for a lower-voltage power supply. In another example, the target creepage distance: is a function of external environmental conditions proximal the primary isolator module 130; and can include increasing the target creepage distance proportional to an air quality value, such as 90, exceeding a threshold air quality value, such as 50. In yet another example, the target creepage distance is a function of external environmental conditions proximal the primary isolator module 130 and can include decreasing the target creepage distance proportional to an air quality value, such as 30, falling below the threshold air quality value, such as 50.

### 5. Sensor Module+Communications

The system 100 can further include a sensor module 110, which includes: a set of inertial sensors (e.g., an accelerometer 112, a gyroscope, a compass, an inertial measurement unit); a humidity sensor (e.g., a hygrometer); a temperature sensor; a controller 190; a wireless communication module; and a battery. The sensor module 110 further includes: a wireless communication module configured to wirelessly transmit data interpreted from these signals; a battery configured to store power from the auxiliary power supply and to power the sensors and the wireless communication module; and a housing configured to contain the sensors, the wireless communication module, the controller 190, and the battery. The sensor module 110 is further configured to mount to a surface of the primary output-side blind bore 133 within the primary core rod 131 of the primary isolator module 130.

In one implementation, shown in FIG. 4, the sensor module 110 is arranged within the primary output-side blind bore 133 and includes: an accelerometer 112 configured to output signals representing oscillations (e.g., vibrations) of the pantograph; a temperature sensor configured to output signals representing temperatures of the primary isolator module 130; a hygrometer configured to output signals representing a humidity level of air proximal the primary isolator module 130; and a gyroscope configured to output signals representing angular velocities of the pantograph. In this implementation, the controller 190 is configured to: access signals from each sensor; interpret data from these signals; and wirelessly broadcast these data to a computing device or a remote computer system 100 (e.g., a remote server) via the wireless communication module.

However, the sensor module 110 can define any other form and can mount to a surface in any other way.

### 6. Power Conversion

Generally, the system 100 is operable in a range of configurations in order to inductively transfer power signals from an auxiliary power supply.

More specifically, the system 100 is operable in a buck configuration to modify (e.g., decrease, attenuate) the voltage of a power signal by: converting a low-voltage direct current power signal to an alternating current power signal at a target operating frequency (e.g., power transmit frequency); supplying the alternating current power signal to the primary transmitter inductor 140; reading a secondary alternating current power signal from the primary receiver inductor 142; and converting the secondary alternating current power signal to a low-voltage direct current power signal; and supplying the low-voltage direct current power signal to electronics in the sensor module 110 (e.g., a battery, a wireless communications module, a set of sensors).

In particular, the system 100 can include: an input power supply 120 circuit operable in a boost configuration to increase voltage of a low-voltage direct current power signal and to supply an alternating current power signal to the primary transmitter inductor 140; and an output power supply 150 circuit operable in a buck configuration to attenuate voltage of a secondary alternating current power signal from the primary receiver inductor 142 and to supply a low-voltage direct current power signal to the sensor module 110.

### 6.1 Input Power Supply Circuit

In one implementation, the system 100 includes an input power supply 120 circuit operable in a boost, buck, or buck-boost configuration to match the voltage of an input auxiliary power signal to the supply voltage of a primary alternating current power signal to the primary transmitter inductor 140.

The input power supply 120 circuit includes: an input voltage supply line configured to supply a low-voltage direct current power signal from a low-voltage power supply, such as a 24 VDC regulated power supply (e.g., an auxiliary power supply, a primary power supply) on a low-voltage power bus of an electric locomotive, such as a light rail, high-speed, main-line, or underground train, tram, or trolley bus; an input ground line; and a primary transmitter inductor 140, arranged on the primary base of the primary input-side blind bore 132 across the primary insulation barrier 134. The input power supply 120 circuit further includes: a DC-to-DC converter (e.g., a boost converter) configured to convert the low-voltage direct current (e.g., 24 VDC) power signal into a higher-voltage direct current (e.g., 100 VDC) power signal; and/or a DC-to-AC converter configured to convert the higher-voltage direct current (e.g., 100 VDC) power signal into a primary alternating current power signal at a power transmit frequency (e.g., 200 kHz) of the primary transmitter inductor 140 and to pass the primary alternating current power signal to the primary transmitter inductor 140.

In one variation, the primary transmitter inductor 140: includes a primary inductive coil (e.g., a pancake coil) that is characterized by a ferrous material; and is configured to output alternating current power signals at the power transmit frequency. The inductive coil is configured to concentrate an oscillating magnetic field within the primary input-side blind bore 132 and toward a secondary inductive coil within a primary output-side blind bore 133 in order to transfer power signals from the auxiliary power supply—such as an auxiliary power supply arranged on an electric locomotive—to the sensor module 110.

### 6.2 Output Power Supply Circuit

In one implementation, the system 100 includes an output power supply 150 circuit operable in a buck configuration: to attenuate voltage of a secondary alternating current power signal, that follows the primary alternating current power signal, from the primary receiver inductor 142; and to supply a low-voltage direct current power signal or low-voltage alternating current power signal to the sensor module 110.

The output power supply 150 circuit includes a primary receiver inductor 142: arranged on the secondary base of the primary output-side blind bore 133 and across the primary insulation barrier 134; arranged opposite and coaxial with the primary transmitter inductor 140; and configured to inductively couple to the primary transmitter inductor 140 and output a secondary alternating current power signal that follows the primary alternating current power signal at the power transmit frequency. The output power supply 150 circuit further includes: an AC-to-DC converter configured to convert a higher-voltage alternating current (e.g., 100 ADC) power signal output by the primary receiver inductor 142 at the power transmit frequency (e.g., 200 kHz) into a higher-voltage direct current power signal and/or a DC-to-DC converter configured to convert the higher-voltage direct current (e.g., 100 VDC) power signal into a low-voltage direct current (e.g., 24 VDC) power signal; an output voltage supply line configured to supply the low-voltage direct current power signal output by the DC-to-DC converter to the sensor module 110; and an output ground line.

In one variation, the primary receiver inductor 142: includes a secondary inductive coil (e.g., a pancake coil) that is characterized by a ferrous material; and is configured to output secondary alternating current power signals at the power transmit frequency. The secondary inductive coil and the primary inductive coil cooperate to concentrate an oscillating magnetic field within the primary output-side blind bore 133, across the primary insulation barrier 134, and within the primary input-side blind bore 132 in order to transfer power signals from the auxiliary power supply—such as an auxiliary power supply arranged on an electric locomotive—to the sensor module 110.

### 6.3 Coupled Inductor Configuration

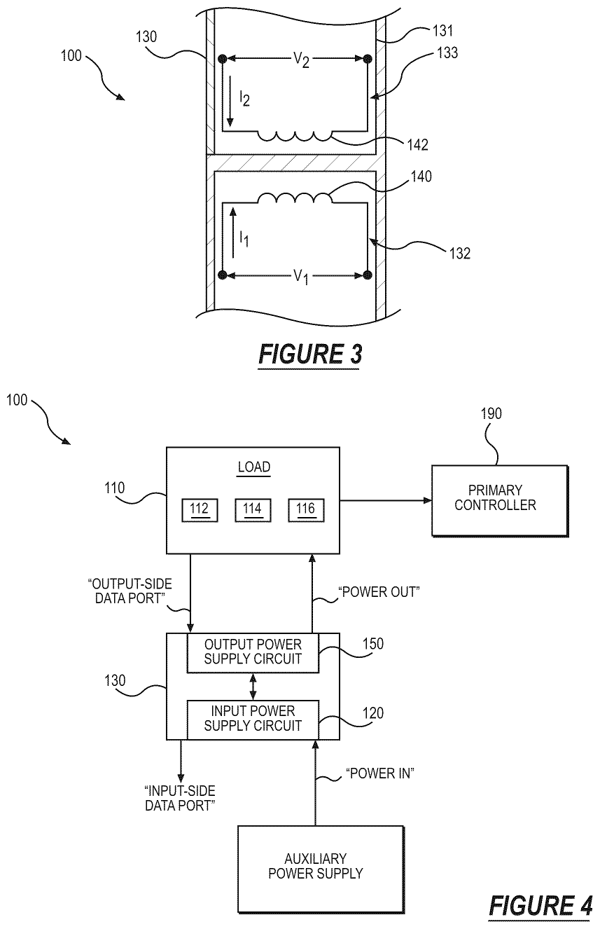

In one implementation, the primary isolator module 130 includes: a primary inductor, such as a transmitter multi-coil inductor; a secondary inductor, such as a receiver multi-coil inductor; and a rectifier. The transmitter multi-coil inductor is configured to output an alternating current power signal, converted within the input power supply 120 circuit, across the primary insulation barrier 134 to the receiver multi-coil inductor at the power transmit frequency. The rectifier: is electrically coupled to the receiver multi-coil inductor; and is configured to convert a secondary alternating current power signal, output by the receiver multi-coil inductor, into a low-voltage direct current power signal in order to enable the primary isolator module 130 to route the low-voltage direct current power signal to the sensor module 110. The controller 190 in the sensor module 110 can then direct the low-voltage direct current power signal to the battery, set of sensors, and/or the wireless communications module. The receiver multi-coil inductor: is arranged on the secondary base of the primary output-side blind bore 133; and is configured to inductively couple to the transmitter multi-coil inductor to output a secondary alternating current power signal at the power transmit frequency for conversion into a low-voltage direct current power signal or a low-voltage alternating current power signal within the output power supply 150 circuit, as shown in FIG. 3.

Furthermore, the transmitter multi-coil inductor defines a transmission axis and a primary size. The transmitter multi-coil inductor can also include a conductive coil arranged about (e.g., encircling) a primary air core. The receiver multi-coil inductor: defines a receiver axis; is characterized by a secondary size approximating the primary size of the transmitter multi-coil inductor; and includes a secondary conductive coil arranged about a secondary air core. The receiver axis of the receiver multi-coil inductor is configured to align with the transmission axis of the transmitter multi-coil inductor to inductively transfer electrical energy across the primary insulation barrier 134.

In one variation, the transmitter multi-coil inductor includes a primary slit conductive coil of a conductive material, such as a copper or aluminum wire coil: supported by the primary base of the primary input-side blind bore 132; and encircling a primary magnetic core of a ferromagnetic material, such as iron or silicon steel. In this variation, the receiver multi-coil inductor includes a secondary slit conductive coil of a conductive material, such as a copper or aluminum wire coil: supported by the secondary base of the primary output-side blind bore 133; and encircling a secondary magnetic core of a ferromagnetic material, such as iron or silicon steel. The primary output-side blind bore 133 and/or the primary input-side blind bore 132 can further include a magnetic material, such as a nanocrystalline alloy. Thus, the primary output-side blind bore 133 and the primary input-side blind bore 132 are configured to: increase the oscillating magnetic field (e.g., concentrate magnetic fields) within the primary core rod 131 between the transmitter multi-coil inductor and the receiver multi-coil inductor; and reduce energy loss in order to enable the primary isolator module 130 to inductively transfer power signals in a primary direction across the primary insulation barrier 134 toward the battery of the sensor module 110.

In another variation, the transmitter multi-coil inductor: includes a primary set of windings of a conductive material, such as copper or aluminum; and encircles a primary magnetic core of a ferromagnetic material, such as silicon steel. The receiver multi-coil inductor: includes a secondary set of windings of a conductive material, such as copper or aluminum; and encircles a secondary magnetic core of a ferromagnetic material, such as silicon steel. In this variation, the primary magnetic core and the secondary magnetic core are configured to increase (e.g., guide, concentrate) the electromagnetic field, between the transmitter multi-coil inductor and the receiver multi-coil inductor to inductively transfer power signals in the primary direction across the primary insulation barrier 134 toward the battery of the sensor module 110.

However, the primary isolator module 130 can include a transmitter multi-coil inductor and a receiver multi-coil inductor of any other conductive coil and any other core. The conductive coil and the core can include any other material and can exhibit any other form.

### 6.4 External Power Supply Configuration

In one implementation, the system 100 includes the input power supply 120 and the output power supply 150 arranged outside of the primary isolator module 130 in order to: reduce thermal loading within the primary core rod 131 and sheds that define the high-voltage isolation path; simplify replacement, serviceability, and shielding of power electronics relative to high-voltage insulation components; and maintain physical separation between power conversion circuitry and the inductive coupling region to minimize electromagnetic interference and preserve dielectric integrity across the primary insulation barrier 134.

For example, the input power supply 120 can correspond to an auxiliary power supply (e.g., a 24 VDC, a 48 VDC regulated power rail): arranged within the electric locomotive; electrically referenced to the ground potential at the chassis; configured to convert a direct-current input voltage into an alternating power signal; and configured to directly supply the alternating power signal to the primary transmitter inductor 140 arranged on the input side of the primary isolator module 130. In this example, the system 100 can further include an enclosure: floating at the voltage potential of the pantograph; housing the output power supply 150 and the sensor module 110; interposed between an output side of the primary isolator module 130 and a support arm of the pantograph; and cooperating with the primary isolator module 130 to electrically isolate the auxiliary power supply from the sensor module 110.

Therefore, rather than constraining the location of the sensor module 110 to within the primary isolator module 130, the system 100 can include the sensor module 110 at one or more locations along the pantograph structure to: increase fidelity of vibration or transient signal capture by the sensor module 110; maintain galvanic isolation from the auxiliary power supply while routing power and data across the primary insulation barrier 134; and support modular integration of sensing hardware across distributed mechanical interfaces of the pantograph.

### 6.5 Internal Power Supply Configuration

In one implementation, the system 100 includes the input power supply 120 and the output power supply 150 arranged within the primary isolator module 130 in order to: reduce total system 100 volume by co-locating power electronics within the dielectric structure of the primary isolator module 130; minimize transmission losses and parasitic inductance by shortening the conductive path between power conversion stages and inductive coupling interfaces; and maintain electromagnetic shielding by enclosing the power conversion circuitry within grounded or partially-grounded materials of the primary isolator module 130.

In one example, the input power supply 120: is arranged within the primary input-side blind bore 132 of the primary isolator module 130; is configured to receive a direct-current input voltage from an auxiliary power supply electrically referenced to the ground potential at the chassis; and is configured to convert the direct-current input voltage into an alternating power signal for inductive transmission across the primary insulation barrier 134. In this example, the output power supply 150 and the sensor module 110 can be arranged within the primary output-side blind bore 133 of the primary isolator module 130. Accordingly, the output power supply 150 can: receive the alternating power signal via inductive coupling of the primary transmitter inductor 140 to the primary receiver inductor 142 across the primary insulation barrier 134; convert the alternating power signal into a direct-current output voltage; and locally supply the direct-current output voltage to the sensor module 110 floating at the voltage potential of the pantograph.

Therefore, the system 100 can locate the input power supply 120 and the output power supply 150 internally within the primary isolator module 130 to: reduce interconnect complexity by eliminating external cabling between power supplies and inductive components; support sealed or encapsulated configurations that increase mechanical durability during operation in harsh rail environments; and integrate control, sensing, and power circuitry within a unified dielectric body.

In another implementation, the system 100 includes a thermally conductive encapsulant (e.g., a filled silicone or epoxy compound) arranged about the input power supply 120 and the output power supply 150 within the primary isolator module 130 to: embed the electronics in a contiguous thermal medium that conducts heat outward from the core region of the primary core rod 131; route the conducted heat along a thermally conductive element (e.g., a metal rod or integrated heat pipe) aligned with a longitudinal axis of the primary core rod 131; and dissipate the heat into ambient air or into structural features (e.g., a mounting bracket) thermally coupled to opposing ends of the primary isolator module 130, thereby supporting operation at power levels exceeding approximately 20 to 30 watts.

### 7. Cross-Boundary Data Communications: Bi-Directional

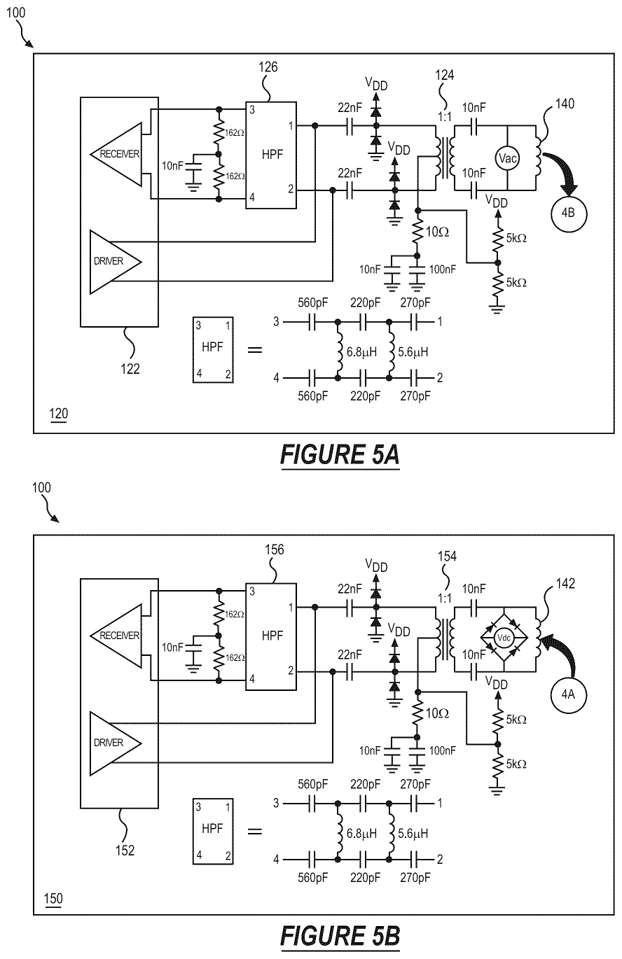

In one implementation, the input power supply 120 circuit includes: an input power line communications (or “PLC”) transceiver 122 (e.g., an input driver and an input receiver); a primary transmitter inductor 140 configured to inductively couple to the primary receiver inductor 142 in the output power supply 150 circuit; an input high-pass filter 126 interposed between the primary transmitter inductor 140 and the input PLC transceiver 122; and an input isolation data-tap transformer 124 interposed between the input high-pass filter 126 and the primary transmitter inductor 140, as shown in FIG. 5A. The output power supply 150 circuit includes: the primary receiver inductor 142; a rectifier electrically coupled to the primary receiver inductor 142; an output PLC transceiver 152 (e.g., an output driver and an output receiver); an output high-pass filter 156 interposed between the primary receiver inductor 142 and the output PLC transceiver 152; and an output isolation data-tap transformer 154 interposed between the output high-pass filter 156 and the primary receiver inductor 142, as shown in FIG. 5B.

Furthermore, the input and output drivers are configured to output an outbound data signal to the input and output isolation data-tap transformers 154. The input and output isolation data-tap transformers 154 are configured to superimpose the outbound data signal—at a data frequency (e.g., 10×, 100× greater than the power transmit frequency)—onto the alternating current power signal via capacitive coupling to generate a modulated data signal. The primary transmitter inductor 140 inductively couples to the primary receiver inductor 142 to pass the modulated data signal across the primary insulation barrier 134. The input and output high-pass filters 156 are coupled to the low-power side of the input and output isolation data-tap transformers 154 and configured to pass higher-frequency components of the composite signal, representing inbound and/or outbound data-over-power alternating current signals, at the data frequency to the input and output PLC transceiver and reject lower-frequency components of the composite signal approximating the power transmit frequency.

Accordingly, the input and output PLC transceiver separate the inbound and/or outbound data signals from this higher-frequency component of the composite signal and outputs the inbound data signal or transmits the outbound data signal.

### 7.1 Bi-Directional Data Uplink

In one implementation, at the input side electronics, the input power supply 120 circuit outputs an alternating current power signal at the power transmit frequency to the primary transmitter inductor 140. The input driver receives an uplink digital data signal—such as a software update or a command—and passes the uplink digital data signal to the input PLC transceiver 122. The input PLC transceiver 122 outputs the uplink digital data signal, modulated at the data frequency (e.g., 2000 kHz), to the input isolation data-tap transformer 124. The input isolation data-tap transformer 124 superimposes the modulated uplink digital data signal onto the power signal to generate an outbound data-over-power alternating current signal and the primary transmitter inductor 140 inductively couples to the primary receiver inductor 142 to pass the data-over-power alternating current signal across the primary insulation barrier 134.

At the output-side electronics, the primary receiver inductor 142 extracts power from the primary transmitter inductor 140 in the form of an inbound data-over-power alternating current signal that follows the outbound data-over-power alternating current signal. The rectifier (or AC-to-DC converter) then extracts power from the outbound data-over-power alternating current signal to output a direct current power signal; and supplies this direct current power signal to the battery and/or to other electronics (e.g., sensors, the controller 190, the wireless communication module) arranged in the primary output-side blind bore 133 or external to the primary isolator module 130. The output isolation data-tap transformer 154 then passes the inbound data-over-power alternating current signal, which follows the outbound data-over-power alternating current signal, to the output high-pass filter 156. The output high-pass filter 156 passes the high-frequency components of the inbound data-over-power alternating current signal to the output PLC transceiver 152 and rejects the low-frequency components of the inbound data-over-power alternating current signal. Accordingly, the output PLC transceiver 152 converts (e.g., demodulates) these high-frequency components of the inbound data-over-power alternating current signal into an uplink digital data signal.

### 7.2 Bi-Directional Data Downlink

In one implementation, at the output-side electronics, the output driver (e.g., an op-amp) receives a downlink digital data signal and passes the downlink digital data signal to the output PLC transceiver 152. The output PLC transceiver 152 outputs the downlink digital data signal, modulated at the data frequency (e.g., 2000 kHz), to the output isolation data-tap transformer 154. The output isolation data-tap transformer 154 then superimposes (or “injects”) the modulated downlink digital data signal onto the alternating current power signal via capacitive coupling to further modify the composite signal.

At the input-side electronics, the input isolation data-tap transformer 124 passes a composite signal—that follows the outbound data-over-power alternating current signal, perturbed according to the downlink digital data signal—to the input high-pass filter 126. The input high-pass filter 126 passes high-frequency components of the composite signal—which represent the modulated downlink digital data signal—to the output PLC transceiver 152. The output PLC transceiver 152 then: receives these high-frequency components of the composite signal; demodulates the digital data signal; and outputs the resulting signal as a downlink digital data signal.

### 7.3 Full-Duplex Configuration

In a full-duplex configuration, the input power supply 120 circuit includes an input band-pass filter: interposed between the low-power side of the input isolation data-tap transformer 124 and the input PLC transceiver 122; and configured to pass signals at a downlink data frequency (e.g., 20 MHz). The output power supply 150 circuit includes an output band-pass filter: interposed between the low-power side of the output isolation data-tap transformer 154 and the output PLC transceiver 152; and configured to pass signals at an uplink data transmit frequency (e.g., 2 MHz).

The input driver is configured to output an uplink digital data signal to the input isolation data-tap transformer 124 at the uplink data frequency. The input isolation data-tap transformer 124 is configured to: superimpose the uplink digital data signal—at the uplink data frequency (e.g., 2 MHz) greater than the power transmit frequency—onto the alternating current power signal via capacitive coupling to generate a composite signal. The output band-pass filter passes signal components of the composite signal—representing outbound data-over-power alternating current signals—around the uplink data frequency (e.g., between 1.9 MHz and 2.1 MHz) to the output PLC transceiver 152. The output PLC transceiver 152 demodulates signal components around the uplink data frequency into an uplink digital data signal.

The output driver is configured to output a downlink digital data signal to the output isolation data-tap transformer 154 at the downlink data frequency. The output isolation data-tap transformer 154 is configured to: superimpose the downlink digital data signal—at the downlink data frequency (e.g., 20 MHz) greater than the power transmit frequency and substantially different from the uplink data transmit frequency—onto the alternating current power signal via capacitive coupling to further modify the composite signal. The input band-pass filter passes signal components of this composite signal—representing inbound data-over-power alternating current signals—around the downlink data frequency (e.g., between 19 MHz and 21 MHz) to the input PLC transceiver 122. The input PLC transceiver 122 demodulates signal components around the downlink data frequency into a downlink digital data signal.

### 8. Variation: Stacked Isolator modules

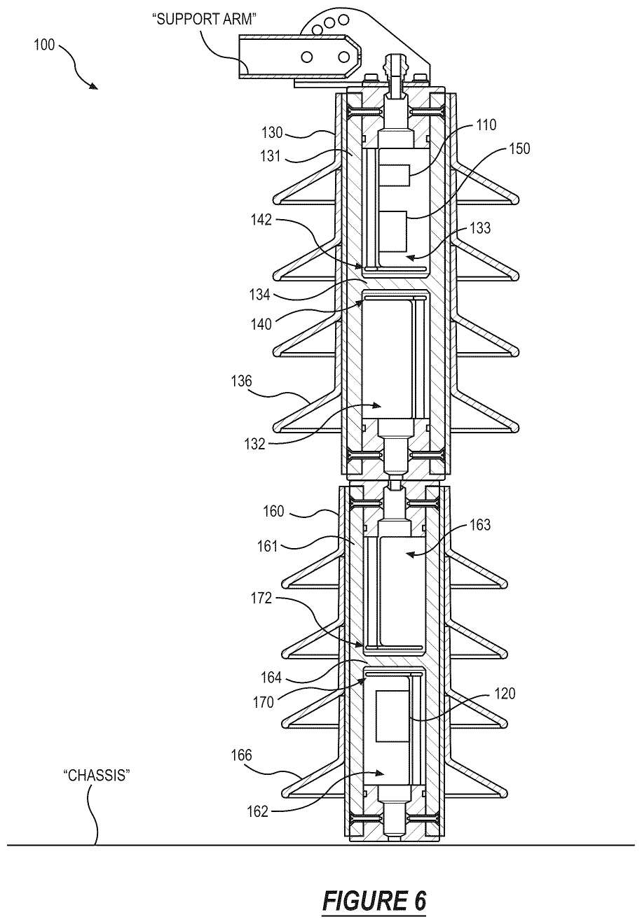

In one variation, shown in FIG. 6, the system 100 can include a set of isolator modules arranged in a vertical stack and configured to form a high-isolation power transfer barrier. The system 100 can direct power signals from the input power supply 120: through a primary isolator module 130 via a primary set of inductors; through a secondary isolator module 160 via a secondary set of inductors; and to the output power supply 150. Additionally, the system 100 can direct data: through the secondary isolator module 160 160 via the secondary set of inductors; through the primary isolator module 130 via the primary set of inductors; and to a wired data output connection and/or to a computing device or remote computer system 100.

For example, the system 100 can include a set of (e.g., two) isolator modules arranged in series and characterized by a combined creepage distance and combined insulation barrier thickness that enables the system 100 to inductively transfer auxiliary power and data signals, such as 24 VDC or 48 VDC. The primary isolator module 130 includes: a primary core rod 131 defining a primary input-side blind bore 132 and configured to house a primary transmitter multi-coil inductor coupled to a primary base of the primary input-side blind bore 132; and a primary output-side blind bore 133 arranged coaxial and offset from the primary input-side blind bore 132 by a primary insulation barrier 134 and configured to house a primary receiver multi-coil inductor coupled to a secondary base of the primary output-side blind bore 133. The primary isolator module 130 further includes a primary set of sheds 136 arranged about the primary core rod 131. The primary insulation barrier 134 defines a primary thickness (e.g., 30 millimeters) approximating a target offset distance (e.g., a gap) between the primary transmitter multi-coil inductor and the primary receiver multi-coil inductor within the primary core rod 131.

The secondary isolator module 160 is arranged in series with the primary isolator module 130. The secondary isolator module 160 includes: a secondary insulated rod defining a secondary input-side blind bore 162 and configured to house a secondary transmitter multi-coil inductor coupled to a third base of the secondary input-side blind bore 162; and a secondary output-side blind bore 163 arranged coaxial and offset from the secondary input-side blind bore 162 by a secondary insulation barrier 164 and configured to house a secondary receiver multi-coil inductor coupled to a fourth base of the secondary output-side blind bore 163. The secondary isolator module 160 further includes a secondary set of sheds 166 arranged about the secondary core rod 161. The secondary insulation barrier 164 defines a secondary thickness (e.g., 30 millimeters) between the secondary transmitter multi-coil inductor and the secondary receiver multi-coil inductor.

In this example, the primary transmitter multi-coil inductor and the primary receiver multi-coil inductor are characterized by a primary coupling coefficient, such as a value between 0 and 1, based on: a primary size of the primary transmitter multi-coil inductor; a secondary size of the primary receiver multi-coil inductor; and the thickness of the primary insulation barrier 134. The secondary transmitter multi-coil inductor and the secondary receiver multi-coil inductor are characterized by a secondary coupling coefficient based on: a third size of the secondary transmitter multi-coil inductor; a fourth size of the secondary receiver multi-coil inductor; and the thickness of the secondary insulation barrier 164.

Therefore, the system 100 can direct alternating current from the primary set of inductors to the secondary set of inductors in order to transfer a power signal. Additionally, the system 100 can implement methods and techniques described above to: direct data-over-power signals from the secondary set of inductors to the primary set of inductors in order to transfer data from the output-side to a wired data output connection or stream to a computing device on the input-side; and direct data-over-power signals from the primary set of inductors to the secondary set of inductors in order to transfer data (e.g., a software update or a command) from the input-side to a wireless communication module on the output-side.

### 9. Backup Isolator Module

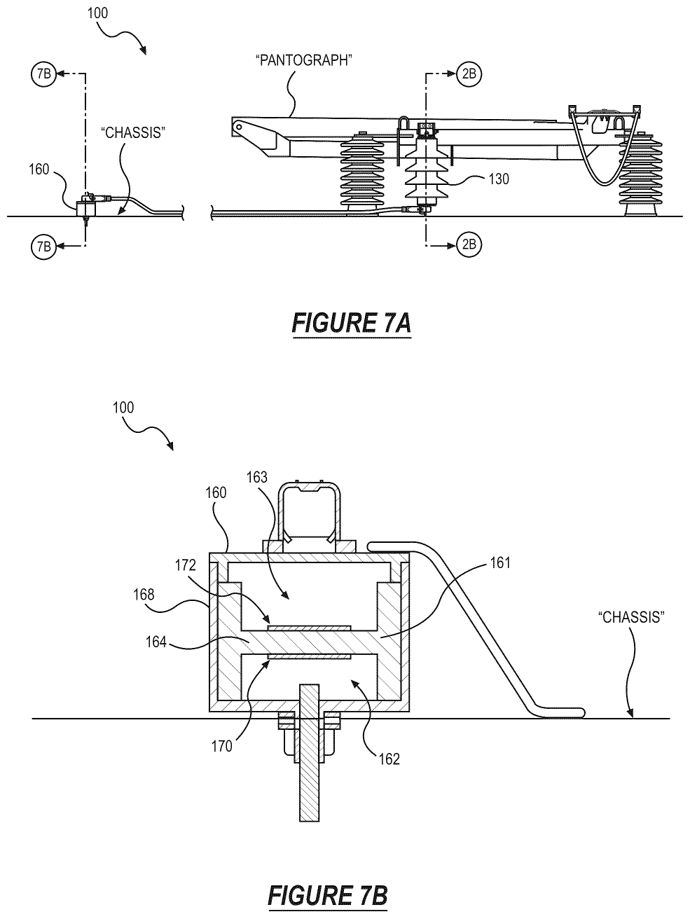

In one implementation, shown in FIGS. 7A and 7B, the system 100 includes a secondary isolator module 160 (or “backup isolator module”): interposed between a primary isolator module 130 coupled to the pantograph and a chassis of the electric locomotive; and configured to, in response to failure of the primary isolator module 130, preserve electrical isolation between the input power supply 120, electrically referenced to the chassis, and the sensor module 110 floating at the voltage potential of the pantograph.

In this implementation, the secondary isolator module 160 can include: a secondary core rod 161; a secondary transmitter inductor 170; a secondary receiver inductor 172; and an enclosure 168. The secondary core rod 161 includes: a secondary input-side blind bore 162; a secondary output-side blind bore 163 concentric with the secondary input-side blind bore 162; and a secondary insulation barrier 164 interposed between the secondary input-side blind bore 162 and the secondary output-side blind bore 163. The secondary transmitter inductor 170 is: coupled to the input power supply 120; and arranged on a third base of the secondary input-side blind bore 162 across the secondary insulation barrier 164. The secondary receiver inductor 172 is: arranged on a fourth base of the secondary output-side blind bore 163, offset from the third base of the secondary input-side blind bore 162, across the secondary insulation barrier 164; coaxial with the secondary transmitter inductor 170; configured to inductively couple to the secondary transmitter inductor 170; and electrically coupled to the primary transmitter inductor 140 of the primary isolator module 130.

The enclosure 168: contains the secondary core rod 161, the secondary transmitter inductor 170, and the secondary receiver inductor 172; and is electrically referenced to the ground potential at the chassis (e.g., via an earthing strap) of the electric locomotive. For example, the enclosure 168: can be formed of a conductive material (e.g., aluminum or grounded metal composite) to define a low-impedance fault path referenced to the roof potential of the electric locomotive; and includes an earthing strap that couples the enclosure 168 to the chassis (e.g., a roof) to divert fault current away from auxiliary wiring referenced to the ground potential. Accordingly, the enclosure 168 cooperates with the secondary insulation barrier 164 to electrically isolate the input power supply 120, electrically referenced to the ground potential at the chassis, from the sensor module 110 floating at the voltage potential of the pantograph.

Therefore, in the event of failure of the primary isolator module 130 (e.g., insulation breakdown, flashover arc,), the secondary isolator module 160 can maintain electrical isolation between the input power supply 120, electrically referenced to the chassis, and the sensor module 110 floating at the voltage potential of the pantograph. Furthermore, in response to detecting failure of the primary isolator module 130, the system can trigger the input power supply 120 to terminate output of the alternating power signal to the secondary transmitter inductor 170 in order to prevent fault current from entering the auxiliary wiring referenced to the ground potential and reduce the risk of electrical shock or equipment damage within the electric vehicle.

### 9.1 Intermediate Voltage Potential

In one implementation, the primary isolator module 130 cooperates with the secondary isolator module 160 to define an intermediate voltage potential (e.g., 12.5 kilovolts) between the voltage potential of the pantograph (e.g., 25 kilovolts) and the ground potential (e.g., zero volts) of the chassis. In this implementation, the primary isolator module 130 includes: a primary output side coupled to a support arm of the pantograph and floating at the voltage potential of the pantograph (e.g., 25 kilovolts); and a primary input side floating at the intermediate voltage potential (e.g., 12.5 kilovolts). Additionally, the secondary isolator module 160 includes: a secondary output side coupled to the primary input side of the primary isolator module 130 and floating at the intermediate voltage potential (e.g., 12.5 kilovolts); and a secondary input side coupled to the input power supply 120 and electrically referenced to the ground potential.

For example, rather than directly coupling the primary input side of the primary isolator module 130 to the chassis, the system 100 includes: a primary input side of the primary isolator module 130 mechanically suspended above the chassis and electrically floating at the intermediate voltage potential; and a cable (e.g., a 25 kV silicone-insulated jumper) that electrically couples the secondary output side of the secondary isolator module 160 to the primary input side of the primary isolator module 130 across an air gap or insulating standoff structure.

Therefore, the system 100 can: support a target insulation rating based on arrangement of the primary insulation barrier 134 of the primary isolator module 130 in series with the secondary insulation barrier 164 of the secondary isolator module 160; include the primary insulation barrier 134 and the second insulation barrier 164 of a reduced thickness (e.g., five millimeters) to increase coupling efficiency between respective inductors; and maintain power transfer from the input power supply 120 and the output power supply 150 while preserving isolation integrity across the total dielectric path formed by the primary isolator module 130 and the secondary isolator module 160. For example, rather than the primary insulation barrier 134 characterized by a thickness of ten millimeters to support a target insulation rating, the system 100 can include: the primary insulation barrier 134 characterized by a thickness of five millimeters; and the secondary insulation barrier 164, also characterized by a thickness of five millimeters, cooperating with the primary insulation barrier 134 to support the target insulation rating.

### 9.2 Power Transfer

In this implementation, the system 100 can transfer an alternating power signal from the input power supply 120 to the output power supply 150 via sequentially inductively coupling through the secondary isolator module 160 and the primary isolator module 130.

For example, the input power supply 120 is configured to drive the alternating power signal to the secondary transmitter inductor 170. Accordingly, the secondary receiver inductor 172 can then: receive the alternating power signal by inductively coupling to the secondary transmitter inductor 170 across the secondary insulation barrier 164; and output the alternating power signal to the primary transmitter inductor 140, such as via the high-voltage-rated cable. The primary receiver inductor 142 can then: receive the alternating power signal by inductively coupling to the primary transmitter inductor 140 across the primary insulation barrier 134; and, as described above, output the alternating power signal to the output power supply 150.

Therefore, the system 100 can: eliminate the need for intermediate power conversion stages between the secondary and primary isolator modules 130; reduce parasitic loss by excluding redundant power regulation stages; and maintain a continuous, galvanically isolated power path from the input power supply 120 to the sensor module 110 floating at the voltage potential of the pantograph.

### 10. Isolation Failure

In one implementation, the system 100 can monitor electrical characteristics of the transmitter inductor 140 and/or the receiver inductor 142 within the primary isolator module 130 to: detect a deviation in voltage amplitude, waveform frequency, or phase characteristics from a nominal coupling profile, such as stored in the controller 190; interpret the deviation as indicative of failure within the primary isolator module 130 and/or the secondary isolator module 160 based on predefined fault criteria; and trigger a fault event in response to one or more waveform parameters exceeding a diagnostic threshold defined by the system 100. In this implementation, the sensor module 110 can include a transient sensor 116 coupled to the receiver inductor 142 at a galvanically isolated sensing node and configured to output waveform measurements representing signal distortion and/or loss of resonance.

Accordingly, the controller 190 can: access a waveform signal from the transient sensor 116; detect sustained waveform anomalies (e.g., detuning, harmonic distortion, amplitude collapse) correlated with isolator failure events based on a deviation of the waveform signal from a target waveform profile; and in response to the deviation exceeding a threshold deviation, output a fault signal, such as through a dedicated diagnostic pin or over a communications interface (e.g., CAN bus, Ethernet) for transmission to onboard or remote diagnostic infrastructure. For example, the controller 190 can: read back-electromotive force signals from the receiver inductor 142 during normal operation and characterize the signal profile under loaded conditions; identify deviation in waveform polarity, amplitude, or symmetry relative to a stored nominal waveform; and classify the deviation as a fault condition within the inductive path of the primary isolator module 130 and/or the secondary isolator module 160.

Therefore, the system 100 can: monitor power transfer behavior across inductive components to detect internal failure of the primary isolator module 130 and/or the secondary isolator module 160; and report the failure through a digital output integrated with the controller 190, input power supply 120, and/or output power supply 150.

### 11. Disclaimer

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system comprising:
a sensor module floating at a voltage potential of a pantograph arranged on an electric vehicle;
an input power supply configured to:
receive a direct-current input voltage from an auxiliary power supply electrically referenced to a ground potential of a chassis of the electric vehicle; and
convert the direct-current input voltage into a first alternating power signal;
an isolator module interposed between the pantograph and the chassis of the electric vehicle, the isolator module comprising:
a core comprising:
an input-side blind bore;
an output-side blind bore concentric with the input-side blind bore; and
an insulation barrier interposed between the input-side blind bore and the output-side blind bore;
a transmitter inductor:
configured to receive the first alternating power signal from the input power supply;
configured to output an intermediate alternating power signal based on the first alternating power signal; and
arranged on a first base of the input-side blind bore across the insulation barrier;
a receiver inductor:
arranged on a second base of the output-side blind bore, offset from the. first base of the input-side blind bore, across the insulation barrier;
coaxial with the transmitter inductor;
configured to receive the intermediate alternating power signal by inductively coupling to the transmitter inductor across the insulation barrier; and
configured to output a second alternating power signal, following the first alternating power signal, based on the intermediate alternating power signal; and
a set of sheds:
arranged about the core; and
cooperating with the insulation barrier to electrically isolate the auxiliary power supply, electrically referenced to the ground potential of the chassis, from the sensor module floating at the voltage potential of the pantograph; and
an output power supply configured to:
receive the second alternating power signal from the receiver inductor;
convert the second alternating power signal into a direct-current output voltage relative to the voltage potential at the pantograph; and
supply the direct-current output voltage to the sensor module.

2. The system of claim 1:
wherein the first transmitter inductor comprises a first coil winding:
defining a transmission axis; and
spanning a first area on the first base of the first input-side blind bore across the first insulation barrier; and
wherein the first receiver inductor comprises a second coil winding:
defining a receiver axis coaxial with the transmission axis;
spanning a second area:
on the second base of the first output-side blind bore across the first insulation barrier; and
approximating the first area; and
cooperating with the first coil winding and the insulation barrier to form a one-to-one transformer that inductively transfers the intermediate alternating power signal across the first insulation barrier.

3. The system of claim 1:
wherein the isolator module comprises:
an output side coupled to a support arm of the pantograph; and
an input side electrically coupled to the chassis of the electric vehicle; and
wherein the set of sheds:
cooperate to define a creepage path between the output side and the input side of the isolator module; and
are configured to:
electrically isolate the voltage potential at the pantograph from the ground potential at the chassis along across the creepage path;
shield the core from surface current leakage across the creepage path; and
shield the core from external environment conditions.

4. The system of claim 1:
wherein the sensor module:
is arranged within the output-side blind bore of the isolator module;
comprises:
an accelerometer configured to output vibration signals representing vibrations of the pantograph; and
a geospatial position module; and
is powered by the auxiliary power supply of the electric vehicle via the isolator module; and
further comprising a controller:
arranged within the output-side blind bore of the isolator module;
powered by the auxiliary power supply of the electric vehicle via the isolator module; and
configured to:
access a geospatial location of the pantograph from the geospatial position module;
access a set of vibration signals, representing vibrations of the pantograph at the geospatial location, from the accelerometer; and
in response to the set of vibration signal exceeding a vibration threshold:
generate a maintenance prompt for repair of an overhead transportation power line at the geospatial location; and
serve the prompt to a maintenance portal.

5. A system comprising:
an electronics module floating at a voltage potential of a pantograph arranged on an electric vehicle;
an input power supply:
electrically referenced to a ground potential at a chassis of the electric vehicle; and
configured to output a first alternating power signal;
a first isolator module interposed between the pantograph and the chassis of the electric vehicle, the first isolator module comprising:
a first core rod comprising:
a first input-side blind bore;
a first output-side blind bore concentric with the first input-side blind bore; and
a first insulation barrier interposed between the first input-side blind bore and the first output-side blind bore;
a first transmitter inductor:
configured to receive the first alternating power signal; and
arranged on a first base of the first input-side blind bore across the first insulation barrier;
a first receiver inductor:
arranged on a second base of the first output-side blind bore, offset from the first base of the first input-side blind bore, across the first insulation barrier;
coaxial with the first transmitter inductor; and
configured to receive the first alternating power signal by inductively coupling to the first transmitter inductor across the first insulation barrier; and
a first set of sheds:
arranged about the first core rod; and
cooperating with the first insulation barrier to electrically isolate the input power supply, electrically referenced to the ground potential of the chassis, from the electronics module floating at the voltage potential of the pantograph; and
an output power supply configured to:
receive the first alternating power signal from the receiver inductor;
convert the first alternating power signal into a direct-current output voltage relative to the voltage potential at the pantograph; and
output the direct-current output voltage to the electronics module.

6. The system of claim 5:
wherein the input power supply comprises an auxiliary power supply:
arranged at the electric vehicle;
electrically referenced to the ground potential at the chassis of the electric vehicle; and
configured to drive the first alternating power signal across the first transmitter inductor to induce inductive coupling between the first transmitter inductor and the first receiver inductor; and
wherein the first isolator module is configured to electrically isolate the auxiliary power supply, electrically referenced to the ground potential of the chassis, from the electronics module floating at the voltage potential of the pantograph.

7. The system of claim 5:
wherein the input power supply:
is arranged within the first input-side blind bore of the first isolator module; and
is configured to:
receive a direct-current input voltage from an auxiliary power supply electrically referenced to the ground potential at the chassis of the electric vehicle;
convert the direct-current input voltage into the first alternating power signal; and
drive the first alternating power signal across the first transmitter inductor to induce inductive coupling between the first transmitter inductor and the first receiver inductor; and
wherein the first isolator module is configured to electrically isolate the auxiliary power supply, electrically referenced to the ground potential, from the electronics module floating at the voltage potential of the pantograph.

8. The system of claim 5:
wherein the first transmitter inductor comprises a first coil winding:
defining a transmission axis; and
spanning a first area on the first base of the first input-side blind bore across the first insulation barrier; and
wherein the first receiver inductor comprises a second coil winding:
defining a receiver axis coaxial with the transmission axis;
spanning a second area:
on the second base of the first output-side blind bore across the first insulation barrier; and
approximating the first area; and
cooperating with the first coil winding and the insulation barrier to form a one-to-one transformer that inductively transfers power from the first alternating power signal across the first insulation barrier.

9. The system of claim 5:
wherein the electronics module:
is arranged within the first output-side blind bore of the first isolator module;
comprises:
an accelerometer configured to output vibration signals representing vibrations of the pantograph; and
a geospatial position module; and
is powered by an auxiliary power supply at the electric vehicle via the first isolator module; and
further comprising a controller:
arranged within the first output-side blind bore of the first isolator module;
powered by the auxiliary power supply at the electric vehicle via the first isolator module; and
configured to:
access a geospatial location of the pantograph from the geospatial position module;
access a set of vibration signals, representing vibrations of the pantograph at the geospatial location, from the accelerometer; and
in response to the set of vibration signals exceeding a vibration threshold:
generate a maintenance prompt for repair of an overhead transportation power line at the geospatial location; and
serve the prompt to a maintenance portal.

10. The system of claim 5:
wherein the input power supply:
is configured to:
drive the first alternating power signal at a first power frequency across the first transmitter inductor; and
receive an uplink data signal at a data frequency, greater than the power frequency, from a controller; and
comprises a first data-tap transformer:
coupled to the first transmitter inductor; and
configured to superimpose the uplink data signal onto the first. alternating power signal to generate an uplink power-data carrier signal;
wherein the first receiver inductor is configured to receive the uplink power-data carrier signal by inductively coupling to the first transmitter inductor across the first insulation barrier; and
wherein the output power supply:
comprises a first high-pass filter configured to:
pass the uplink data signal at the data frequency in the uplink power-data carrier signal; and
reject the first alternating power signal at the power frequency in the uplink power-data signal; and
is configured to output the uplink data signal to a data input of the electronics module.

11. The system of claim 10:
wherein the output power supply:
is configured to receive a downlink data signal at the data frequency, greater than the power frequency, from the electronics module; and
comprises a second data-tap transformer:
coupled to the first receiver inductor; and
configured to superimpose the downlink data signal onto the first alternating power signal to generate a downlink power-data carrier signal;
wherein the first transmitter inductor is configured to receive the downlink power-data carrier signal by inductively coupling to the first receiver inductor across the first insulation barrier; and
wherein the input power supply:
comprises a second high-pass filter configured to:
pass the downlink data signal at the data frequency in the downlink power-data carrier signal; and
reject the first alternating power signal at the power frequency in the downlink power-data signal; and
is configured to output the downlink data signal to the controller.

12. The system of claim 5:
wherein the first isolator module comprises:
a first output side coupled to a support arm of the pantograph; and
a first input side coupled to the chassis of the electric vehicle; and
wherein the first set of sheds:
cooperate to define a first creepage path between the first output side and the first input side of the first isolator module; and
are configured to:
electrically isolate the voltage potential at the pantograph from the ground potential at the chassis along across the first creepage path;
shield the first core rod from surface current leakage across the first creepage path; and
shield the first core rod from external environment conditions.

13. The system of claim 5, further comprising a second isolator module:
arranged in series with the first isolator module;
interposed between the first isolator module and the chassis of the electric vehicle;
comprising:
a second core rod coaxial with the first core rod and comprising:
a second input-side blind bore;
a second output-side blind bore concentric with the second input-side blind bore; and
a second insulation barrier interposed between the second input-side blind bore and the second output-side blind bore;
a second transmitter inductor:
coupled to the input power supply; and
arranged on a third base of the second input-side blind bore across the second insulation barrier; and
a second receiver inductor:
arranged on a fourth base of the second output-side blind bore, offset from the third base of the second input-side blind bore, across the second insulation barrier;
coaxial with the second transmitter inductor;
configured to inductively couple to the second transmitter inductor; and
coupled to the first transmitter inductor of the first isolator module; and
a second set of sheds arranged about the second core rod; and
cooperating with the first isolator module to electrically isolate the input power supply, electrically referenced to the ground potential, from the electronics module floating at the voltage potential of the pantograph.

14. The system of claim 13:
wherein the input power supply is configured to drive the first alternating power signal across the second transmitter inductor;
wherein the second receiver inductor is configured to:
receive the first alternating power signal by inductively coupling to the second transmitter inductor across the second insulation barrier; and
output the first alternating power signal to the first transmitter inductor; and
wherein the first receiver inductor is configured to:
receive the first alternating power signal by inductively coupling to the first transmitter inductor across the first insulation barrier; and
output the first alternating power signal to the output power supply.

15. The system of claim 13:
wherein the first isolator module comprises a first output side coupled to a support arm of the pantograph;
wherein the second isolator module comprises:
a second output side coupled to a first input side of the first isolator module; and
a second input side coupled to the chassis of the electric vehicle; and
wherein the second set of sheds cooperate with the first set of sheds to:
define a first creepage path between the first output side of the first isolator module and the second input side of the second isolator module;
electrically isolate the voltage potential at the pantograph from the ground potential at the chassis along across the first creepage path;
shield the first core rod and the second core rod from surface current leakage across the first creepage path; and
shield the first core rod and the second core rod from external environment conditions.

16. The system of claim 5, further comprising a second isolator module:
arranged on the chassis of the electric vehicle;
laterally offset from the first isolator module; and
comprising:
a second core rod comprising:
a second input-side blind bore;
a second output-side blind bore concentric with the second input-side blind bore; and
a second insulation barrier interposed between the second input-side blind bore and the second output-side blind bore;
a second transmitter inductor:
coupled to the input power supply; and
arranged on a third base of the second input-side blind bore across the second insulation barrier;
a second receiver inductor:
arranged on a fourth base of the second output-side blind bore, offset from the third base of the second input-side blind bore, across the second insulation barrier;
coaxial with the second transmitter inductor;
configured to inductively couple to the second transmitter inductor; and
coupled to the first transmitter inductor of the first isolator module; and
an enclosure:
containing the second core rod, the second transmitter inductor, and the second receiver inductor; and
electrically referenced to the ground potential at the chassis of the electric vehicle; and
cooperating with the first isolator module to electrically isolate the input power supply, electrically referenced to the ground potential, from the electronics module floating at the voltage potential of the pantograph.

17. The system of claim 16:
wherein the input power supply is configured to drive the first alternating power signal to the second transmitter inductor;
wherein the second receiver inductor is configured to:
receive the first alternating power signal by inductively coupling to the second transmitter inductor across the second insulation barrier; and
output the first alternating power signal to the first transmitter inductor; and
wherein the first receiver inductor is configured to:
receive the first alternating power signal by inductively coupling to the first transmitter inductor across the first insulation barrier; and
output the first alternating power signal to the output power supply.

18. The system of claim 16:
wherein the first isolator module comprises:
a first output side:
coupled to a support arm of the pantograph; and
floating at the voltage potential of the pantograph; and
a first input side floating at an intermediate potential between the voltage potential at the pantograph and the ground potential at the chassis; and
wherein the second isolator module:
comprises:
a second output side:
coupled to the first input side of the first isolator module; and
floating at the intermediate potential; and
a second input side:
coupled to the input power supply; and
electrically referenced to the ground potential at the chassis of the electric vehicle; and
is configured to isolate the input power supply, electrically referenced to the ground potential, from the first input side of the first isolator module floating at the intermediate potential.

19. An isolator module comprising:
a core comprising:
an input-side blind bore;
an output-side blind bore concentric with the input-side blind bore; and
an insulation barrier interposed between the input-side blind bore and the output-side blind bore;
a transmitter inductor:
arranged on a first base of the input-side blind bore across the insulation barrier; and
configured to receive a first power signal from a power supply electrically referenced to a first potential; and
a receiver inductor:
arranged on a second base of the output-side blind bore, offset from the first base of the input-side blind bore, across the insulation barrier;
coaxial with the transmitter inductor;
configured to inductively couple to the transmitter inductor; and
configured to output a second power signal, following the first power signal, to an electronics module floating at a second potential greater than the first potential; and
a set of sheds:
arranged about the core; and
cooperating with the insulation barrier to electrically isolate the power supply, electrically referenced to the first potential, from the electronics module floating at the second potential.

20. The isolator module of claim 19:
wherein the isolator module is interposed between a pantograph and a chassis of an electric vehicle;
wherein the electronics module:
is arranged within the output-side blind bore of the isolator module;
comprises:
an accelerometer configured to output vibration signals representing vibrations of the pantograph; and
a geospatial position module; and
is powered by the power supply via the first isolator module, the power supply arranged within the input-side blind bore; and
further comprising a controller:
arranged within the output-side blind bore of the isolator module;
powered by the power supply via the first isolator module; and
configured to:
access a geospatial location of the pantograph from the geospatial position module;
access a set of vibration signals, representing vibrations of the pantograph at the geospatial location, from the accelerometer; and
in response to the set of vibration signals exceeding a vibration threshold:
generate a maintenance prompt for repair of an overhead transportation power line at the geospatial location; and
serve the prompt to a maintenance portal.
